(19) United States
(12) Patent Application Publication
(10) Pub. No.: US 2026/0281070 A1
(43) Pub. Date: Sep. 17, 2026

(54) INFORMATION PROCESSING METHOD, TERMINAL AND STORAGE MEDIUM

(71) Applicant: Beijing Zitiao Network Technology Co., Ltd., Beijing (CN)

(72) Inventors: Wei CAI, Beijing (CN); Chen WANG, Beijing (CN); Jinrui CHENG, Beijing (CN); Ang ZHANG, Beijing (CN); Luobin LI, Beijing (CN); Min ZHANG, Beijing (CN); Huiming WANG, Beijing (CN); Hui JIA, Beijing (CN); Qiyang LIU, Beijing (CN); Penglin LI, Beijing (CN); Jiaxuan WANG, Beijing (CN); Penghui LI, Beijing (CN); Bokun ZHOU, Beijing (CN); Jiachen ZHAO, Beijing (CN)

(21) Appl. No.: 18/868,456

(22) PCT Filed: Jul. 3, 2023
(86) PCT No.: PCT/CN2023/105586

§ 371 Date: Nov. 22, 2024

(30) Foreign Application Priority Data
Jul. 5, 2022 (CN) 202210793629.0

(51) Int. Cl. H04L 51/216; H04L 51/224

(52) U.S. Cl. CPC H04L 51/216; H04L 51/224

(57) ABSTRACT

Provided in the present disclosure are an information processing method, a terminal and a storage medium. The information processing method includes: in response to an operation of sending a first message in a first conversation, displaying the first message in a conversation detail page of the first conversation, wherein the first conversation is not a topic group; in response to a topic creation operation for the first message in the first conversation, creating a first topic including the first message; and when there is a new message in the first topic, notifying members in the first conversation according to a preset notification policy, wherein in the preset notification policy, different notification policies are used according to different degrees of participation of different members in the first topic.

### CROSS-REFERENCE TO RELATED APPLICATION

This application is a national phase filing of International Patent Application No. PCT/CN2023/105586, filed on Jul. 3, 2023, which is based on China patent application with application number of 202210793629.0 and application date of Jul. 5, 2022, entitled “information processing method and apparatus, terminal and storage medium”, and claims the priority of the China patent application. The disclosure of the above China patent application is incorporated herein by reference.

### TECHNICAL FIELD

The present disclosure relates to the field of computer technology, and in particular, to an information processing method and apparatus, terminal and storage medium.

### BACKGROUND

Conversations can be made between users through the communication software. The ways of conversation include a one-on-one chat conversation between two users and a group chat conversation between three or more users. Users communicate by sending communication information in the conversation.

### SUMMARY

The present disclosure provides an information processing method and apparatus, terminal and storage medium.

The present disclosure adopts the following technical solutions.

In some embodiments, the present disclosure provides an information processing method including:
displaying a first message in a conversation detail page of a first conversation in response to an operation of sending the first message in the first conversation, wherein the first conversation is not a topic group;
creating a first topic including the first message in response to a topic creation operation for the first message in the first conversation; and
notifying members in the first conversation according to a preset notification policy when a new message appears in the first topic, wherein in the preset notification policy, different notification policies are adopted according to different degrees to which different members participate in the first topic.

In some embodiments, the present disclosure provides an information processing apparatus, including a displaying unit, a control unit and a notification unit,
the displaying unit is configured to display a first message in a conversation detail page of a first conversation in response to an operation of sending the first message in the first conversation, wherein the first conversation is not a topic group;
the control unit is configured to create a first topic including the first message in response to a topic creation operation for the first message in the first conversation;
the notification unit is configured to notify members in the first conversation according to a preset notification policy when a new message appears in the first topic, wherein in the preset notification policy, different notification policies are adopted according to different degrees to which different members participate in the first topic.

In some embodiments, the present disclosure provides a terminal, including at least one memory and at least one processor,
wherein the at least one memory is configured to store program code, and the at least one processor is configured to invoke the program code stored by the at least one memory to perform any of the methods described above.

In some embodiments, the present disclosure provides a computer-readable storage medium for storing program code which, when executed by a processor, causes the processor to perform any of the methods described above.

The information processing method proposed in the embodiment of the present disclosure includes: displaying a first message in a conversation detail page of a first conversation in response to an operation of sending the first message in the first conversation, wherein the first conversation is not a topic group; creating a first topic including the first message in response to a topic creation operation for the first message in the first conversation; and notifying members in the first conversation according to a preset notification policy when a new message appears in the first topic, wherein in the preset notification policy, different notification policies are adopted according to different degrees to which different members participate in the first topic. The method of the present disclosure can adopt different notification strategies according to the degree of participation of different members in the first topic, realize differentiated reminders, and reduce the disturbance to members with low topic participation in the conversation.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic and components and elements are not necessarily drawn to scale.

FIG. 1 is a flowchart of an information processing method of an embodiment of the present disclosure.

FIGS. 2-8 are schematic diagrams of display interfaces of a communication client according to embodiments of the present disclosure.

FIG. 9 is a structural schematic diagram of an electronic device of an embodiment of the present disclosure.

### DETAILED DESCRIPTION

Embodiments of the present disclosure will be described in more detail below with reference to the accompanying drawings. While some embodiments of the present disclosure are illustrated in the accompanying drawings, it should be understood that the present disclosure may be embodied in various forms and should not be construed as limited to the embodiments set forth herein, but rather, these embodiments are provided for a more thorough and complete understanding of the disclosure. It should be understood that the drawings and examples of the present disclosure are for exemplary purposes only and are not intended to limit the scope of the present disclosure.

It should be understood that the various steps recited in the method implementation of the present disclosure may be performed in and/or in parallel. Further, the method implementation may include additional steps and/or omit performing illustrated steps. The scope of the present disclosure is not limited in this regard.

As used herein, the term “include” and variations thereof are open inclusion, that is, “including, but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the description below.

Note that the concepts of “first”, “second”, and the like mentioned in the present disclosure are used only to distinguish different devices, modules, or units, and are not used to limit the order or interdependence of functions performed by these devices, modules, or units.

It is noted that modifications referred to as “a” or “an” in the present disclosure are illustrative rather than limiting, and those skilled in the art should understand that “one or more” should be understood unless the context clearly dictates otherwise.

The names of messages or information interacted between devices in an implementation of the present disclosure are for illustrative purposes only and are not intended to limit the scope of such messages or information.

Hereinafter, the solution provided by the embodiments of the present disclosure will be described in detail in conjunction with the accompanying drawings.

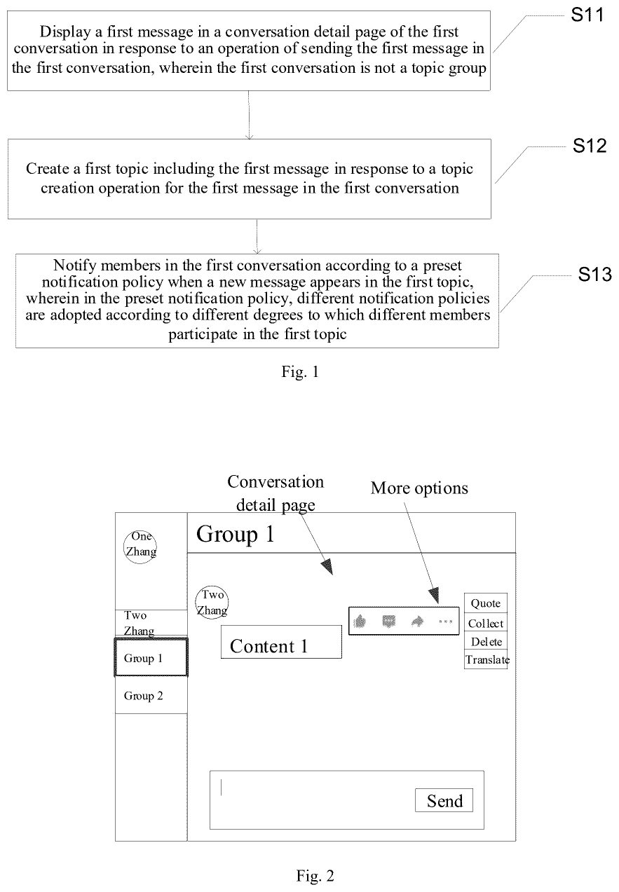

As shown in FIG. 1, FIG. 1 is a flowchart of an information processing method of an embodiment of the present disclosure, includes Step S11 to Step S13 as follows.

S11: displaying a first message in a conversation detail page of the first conversation in response to an operation of sending the first message in the first conversation, wherein the first conversation is not a topic group.

In some embodiments, the information processing method proposed in embodiments of the present disclosure can be used for communication clients (e.g., communication clients such as instant communication clients), as well as for collaborative office platforms integrated with communication functions. The operation of sending the first message may be that the member of the first conversation clicks a send button after entering the first message in the information input box of the first conversation. The first conversation has a conversation detail page, which may be a chat interface for the first conversation that may be used to display messages in the first conversation. The first conversation may be a group chat conversation, but the first conversation is not a topic group. A topic group may refer to a group whose group messages are all published in the form of a topic, and since the first conversation is not a topic group, the first message may not be a topic, but rather a communication message that is different from a topic. The first conversation may be a conversation in which messages are presented chronologically, one by one, in general groups, meeting groups, project groups, and the like. The first conversation can be either a one-on-one chat conversation or a group chat conversation.

S12: Creating a first topic including the first message in response to a topic creation operation for the first message in the first conversation.

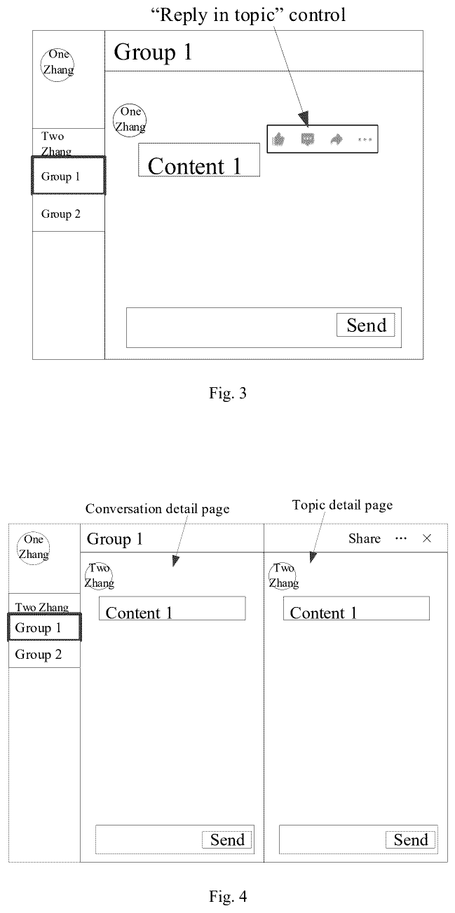

In some embodiments, the topic creation operation may be, for example, a triggering operation on a topic creation control for a first message. Such as shown in FIG. 2, Group 1 in FIG. 2 is a first conversation, “Content 1” sent by Two ZHANG is a first message, the first message has an associated control, one or more controls exist in the associated controls, and more options may exist for displaying more controls. Such as shown in FIG. 3, the topic creation operation may be, for example, to trigger a “Reply in Topic” control of the first message, and the “Reply in Topic” control, when triggered, will automatically create a first topic containing the first message based on the first message that is a non-topic message, such as by converting the first message to the first topic. As shown in FIG. 4, after the first topic is created, a sidebar may be presented in the conversation detail page of the first conversation (Group 1 in FIG. 4), a topic detail page is presented in the sidebar, the first topic is displayed in the topic detail page, and a reply may be made to the first topic in an information input box of the topic detail page.

S13: notifying members in the first conversation according to a preset notification policy when a new message appears in the first topic, wherein in the preset notification policy, different notification policies are adopted according to different degrees to which different members participate in the first topic.

In some embodiments, a member of the first conversation may view the first topic at the topic detail page by clicking on the first topic in the conversation detail page to open the topic detail page. The presence of a new message in the first topic may be, for example, the presence of a user's reply to the first topic, and the like, and the preset notification policy may account for one or more types of notification, including, for example, no notification, sound notification, visual notification, sound plus vibration notification, and the like. Different members of the first conversation may have different degrees of participation in the first topic. The degree of participation in the first topic may include, for example, participation in the first topic, non-participation in the first topic, participation in the first topic may also be categorized into one or more different levels of participation. For different degrees of participation in the first topic, different notification policies may be employed, respectively, e.g., when there is a new message in the first topic, the notification strength for members participating in the first topic of the manner of notification may increase as the depth of the degree of participation in the first topic increases.

In some embodiments of the present disclosure, a first message may be published and converted to a first topic in a non-topic group, enabling publication of a topic in the non-topic group. And when there is a new message in the first topic, different notification policies are adopted based on the degree of participation of different members in the first conversation, and if a single reminder policy is adopted, the notification policies of each type of notification are substantially the same, the members who are not or have a low degree of relevance to the topic are easily disturbed, and the members cannot determine the degree of relevance of the current notification to himself according to the difference in the notification policy. The method proposed in the embodiment of the present disclosure can distinguish the degree of relevance of the notification to himself by the notification policy.

In some embodiments of the present disclosure, when there is a new message in the first topic, notifying a member in the first conversation according to a preset notification policy includes: when there is a new message in the first topic, adopting a first notification policy for a member participating in the first topic in the first conversation, and adopting a second notification policy for a member not participating in the first topic in the first conversation, wherein a notification strength of the first notification policy is higher than a notification strength of the second notification policy.

In some embodiments, the first topic is a topic in the first conversation, and when there is a new message in the first topic, it indicates that there is a new message in the first conversation, and the related art generally uses a uniform reminder for a new message in a conversation. In this embodiment, a first notification policy and a second notification policy are set that are different in notification intensity. the higher the notification intensity, the more significant the reminder to the member, for example, the notification intensity of a ringing reminder is higher than that of a silent reminder, and the notification intensity of a shock-plus-ringing reminder is higher than that of a ringing reminder. For members who participate in the first topic, they are more focused on the dynamics of the first topic, while for members who do not participate in the first topic, they tend to be less focused on the dynamics of the first topic, thus enabling the first notification policy to have a higher notification intensity than the second notification policy, thereby enabling users who participate in the first topic to notice new messages in the first topic more easily than users who do not participate in the first topic, and also reducing distraction to members who do not participate in the first topic.

In some embodiments of the present disclosure, the members of the first conversation who participate in the first topic include: members who have replied to the first topic; Or members who have replied to the first topic and members who have subscribed to the first topic through a topic subscription operation, or members who have replied to the first topic and members mentioned in new messages; Optionally, members who have replied to the first topic, members who have subscribed to the first topic through a topic subscription operation, and members mentioned in new messages.

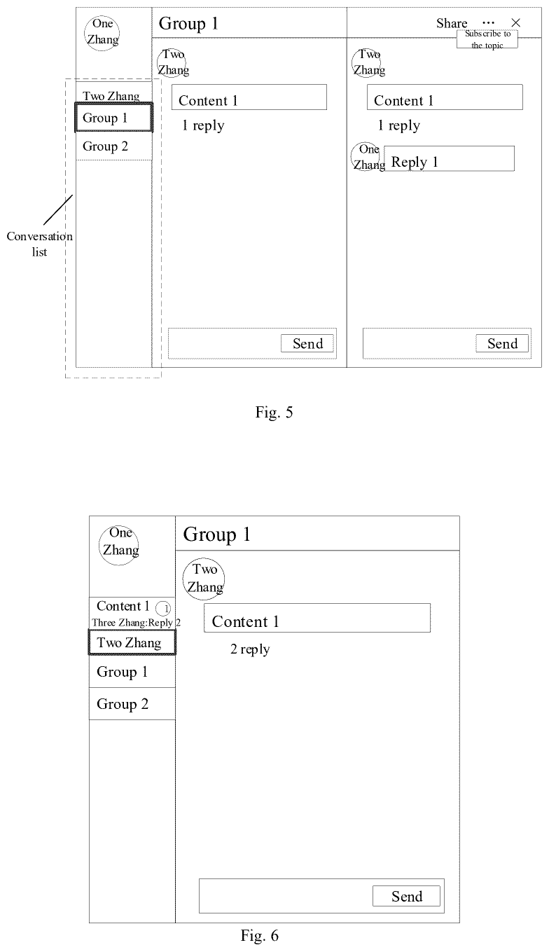

In some embodiments, a member of the first conversation becomes a member participating in the first topic upon replying to the first topic, e.g., as shown in FIG. 5, One ZHANG participates in the first topic by replying to the first topic of Two ZHANG. In some embodiments, a subscription may be made to a first topic, for example, as shown in the upper right corner of FIG. 5, a control to subscribe to the topic may be displayed in the topic detail page where the first topic is located, and the control may be triggered to subscribe to the first topic. In some embodiments, other members may be mentioned in the new message, which may be in the form of@members, and the member being@automatically becomes a member participating in the first topic.

In some embodiments of the present disclosure, employing the first notification policy for a member participating in the first topic in the first conversation when there is a new message in the first topic includes, for a member participating in the first topic in the first conversation, displaying first information of the first topic in a conversation list of the member when there is a new message in the first topic. In some embodiments, the first information of the first topic includes: identification information of the first topic and preview information of the new message.

In some embodiments, a conversation list is used to display each conversation. As shown in FIG. 5, the conversation list is an area where “Two ZHANG”, “Group 1”, and “Group 2” are located on the left side of FIG. 5 for entering each conversation. After generating a new message in the first topic, the first information of the first topic is displayed in the conversation list, so that the first topic can be opened in a manner similar to entering a conversation. Taking the example of a new message as Three ZHANG reply to a first topic, please refer to FIGS. 5 and 6, if Three ZHANG replies “Reply 2” to the first topic “Content 1” in the first conversation, the first information “Content 1 Three ZHANG: Reply 2” for the first topic will be displayed in the conversation list. The identification information of the first topic may include at least one of an avatar, a name of the first topic, for example, the identification information of the first topic is “Content 1” in FIG. 6, and the preview information of the new message is “Three ZHANG: Reply 2”. By displaying the first information in the conversation list such that the first information is presented in a conversation portal-like manner, the first information can be made to participate in the ordering of the conversations in the conversation list, the various member items in the conversation list (including the conversations and the first information) can be ordered in order of update time, the newer the update time, the closer the rank is to the top.

In some embodiments of the present disclosure, adopting the first notification policy for the member participating in the first topic in the first conversation includes, for the member participating in the first topic in the first conversation, pushing a voice alert notification or a visual alert notification to the members when there is a new message in the first topic.

In some embodiments, the voice alert notification may be sounding an alert tone, and the visual alert notification may be in various ways, for example, the notification message may be pushed in the notification bar, the first conversation may be controlled to flash, the first information may be controlled to flash, or, as shown in FIG. 6, the message identification may be displayed in the area where the first information is located in the conversation list, and the number of unread messages may be displayed in the message identification (number 1 shown in the circle in FIG. 6).

In some embodiments of the present disclosure, the method further includes, in response to triggering the operation of the first information of the first topic displayed in the conversation list, displaying content of the first topic in the conversation detail page display area of the client interface of the member.

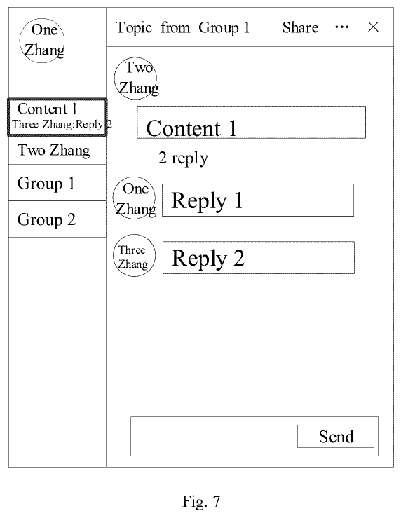

In some embodiments of the present disclosure, as shown in FIG. 6, the first information is displayed in the conversation list, the first information may be triggered by clicking or the like, and after the first information of the first topic is triggered, the content of the first topic may be displayed in the conversation detail page display area of the client interface as shown in FIG. 7, and the content of the first topic may be displayed as originating from the first conversation. There may not be a switch to the first conversation, as shown in FIG. 7, the first conversation is Group 1, the first conversation “Group 1” is not selected after the first message is triggered, the conversation detail page of the first conversation may be opened if the first conversation in the list of conversations is clicked on, and thus, the current display position in the first conversation may not be affected by this way of opening the first topic. After the content of the first topic is displayed in the conversation detail page display area of the client interface of the member, the position displayed in the conversation detail page of the first conversation may be, after the first topic is switched back by clicking on the first conversation in the list of conversations, the location viewed by the user before the conversation detail page display area of the member's client interface displays content of the first topic. Thus, the user may not lose location in the first conversation when viewing the first topic, which may facilitate the user comparing content in the first topic with other content in the first conversation.

In some embodiments of the present disclosure, adopting the second notification policy for the member not participating in the first topic in the first conversation when there is a new message in the first topic includes one or more of: not notifying, in a conversation list of the member, the member not participating in the first topic in the first conversation when there is a new message in the first topic; When there is a new message in the first topic, for members participating in the first topic in the first conversation, no audio or visual alert notification is pushed to the members.

In some embodiments, a member of the first conversation who is not participate in the first topic may be less concerned with the dynamics of the first topic, and thus compared with a member of the first conversation who is participate in the first topic, the notification intensity may be reduced, the notification may not be made in the conversation list of the member, and the voice alert notification and the visual alert notification may not be pushed,. This reduces distraction to members not participating in the first topic.

In some embodiments of the present disclosure, the method further includes moving the first topic into a do-not-disturb conversation group of the first user in response to an operation performed on the first topic by the first user participating in the first topic to close the notification.

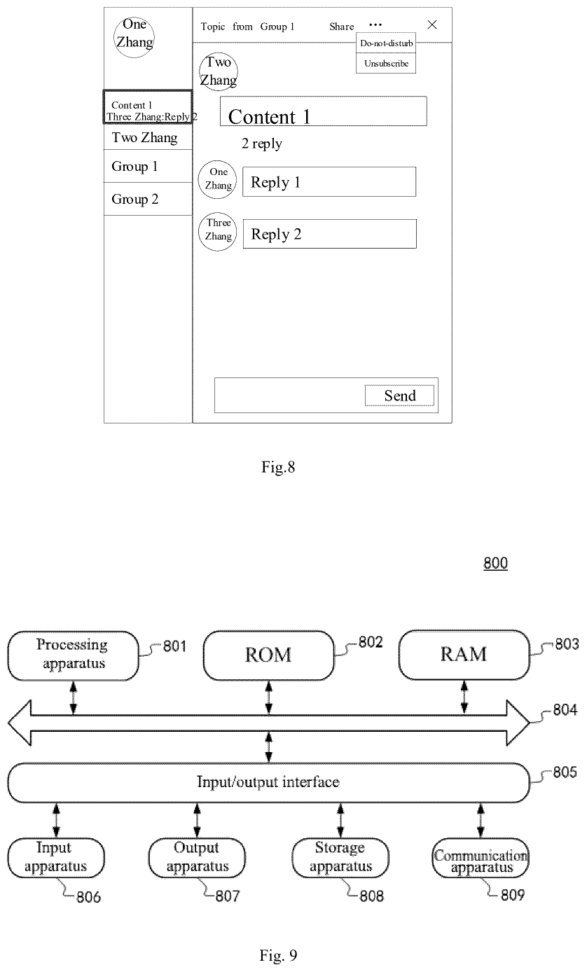

In some embodiments, for the first user participating in the first topic, the first topic may be subsequently not expected to be disturbing to himself, at which point the first topic may be moved into a do-not-disturb group. For the first topic in the do-not-disturb group, notification may still be made when a new message is generated, but the notification intensity is reduced, e.g., an audio alert notification may no longer be pushed, a visual alert notification may remain, e.g., a message identification may only be displayed at the first information of the first topic in the conversation list when a new message is generated in the first topic. In some embodiments, moving the first topic into a do-not-disturb conversation group may not affect the first conversation, i.e., the first conversation is not in a do-not-disturb group, in which case new messages in the first conversation that are not related to the first topic may be notified in accordance with the notification strength of the first conversation originally. For example, if the first conversation was originally a non-do-not-disturb group, new messages in the first conversation that are not related to the topic may be notified in accordance with the non-do-not-disturb group, thereby enabling different messages in a conversation to be alerted in accordance with different settings. As shown in the upper right corner of FIG. 8, the first topic may be introduced into the do-not-disturb conversation group by triggering the do-not-disturb control associated with the first topic. If the user wants to no longer receive information related to the first topic, the unsubscribe control associated with the first topic may be triggered, and then the user can become a user who does not participate in the first topic.

In some embodiments of the present disclosure, the method further includes: displaying a subscribe topic control in a first topic-related interface of a second user who is not subscribed to the first topic; The subscribe topic control, when triggered, causes a second user to subscribe to the first topic. In some embodiments of the present disclosure, displaying an unsubscribe control in a first topic-related interface of a third user who has subscribed to the first topic; The unsubscribe control, when triggered, causes a third user to unsubscribe to the first topic.

In some embodiments, as shown in FIG. 5, for a second user who is not subscribed to the first topic, the second user may be a member who is not participate in the first topic, for a member who is not participate in the first topic, who may subscribe to the first topic through the subscribe topic control associated with the first topic, thereby becoming a member who is participate in the first topic. The first topic-related interface may be a topic detail page that may be displayed by triggering the first topic in the first conversation. In some embodiments, for a third user who has subscribed to the first topic, upon opening the first topic-related interface, the subscribe topic control is no longer displayed and the unsubscribe control is displayed.

In some embodiments of the present disclosure, an information processing apparatus is also proposed, including a displaying unit, a control unit and a notification unit,
the displaying unit is configured to display a first message in a conversation detail page of a first conversation in response to an operation of sending the first message in the first conversation, wherein the first conversation is not a topic group;
the control unit is configured to create a first topic including the first message in response to a topic creation operation for the first message in the first conversation;
the notification unit is configured to notify members in the first conversation according to a preset notification policy when a new message appears in the first topic, wherein in the preset notification policy, different notification policies are adopted according to different degrees to which different members participate in the first topic.

In some embodiments, the notifying members in the first conversation according to a preset notification policy when a new message appears in the first topic includes: adopting a first notification policy for a member participating in the first topic in the first conversation and adopting a second notification policy for a member not participating in the first topic in the second conversation when a new message appears in the first topic,
wherein a notification strength of the first notification policy is higher than a notification strength of the second notification policy.

In some embodiments, the member participating in the first topic in the first conversation including: a member who has replied to the first topic; or a member who has replied to the first topic and a member who has subscribed to the first topic through a topic subscription operation; or a member who has replied to the first topic and a member mentioned in the new message; or a member who has replied to the first topic, a member who has subscribed to the first topic through a topic subscription operation, and a member mentioned in the new message.

In some embodiments, the adopting a first notification policy for a member participating in the first topic in the first conversation when a new message appears in the first topic including one or more of:
displaying first information of the first topic in a conversation list of the member participating in the first topic in a first conversation when the new message appears in the first topic;

In some embodiments, the first information of the first topic including: identification information of the first topic and preview information of the new message.
pushing a voice alert notification or a visual alert notification to the member participating in the first topic in the first conversation when the new message appears in the first topic.

In some embodiments, the control unit is further configured to display content of the first topic in a conversation detail page display area of a client interface of the member in response to triggering an operation of the first information of the first topic displayed in the conversation list.

In some embodiments, the adopting a second notification policy for a member not participating in the first topic in the second conversation when a new message appears in the first topic including one or more of:
not notifying, in a conversation list of the member, the member not participating in the first topic in the first conversation when the new message appears in the first topic;
not pushing audio alert notification or visual alert notification to the member participating in the first topic in the first conversation when the new message appears in the first topic.

In some embodiments, the control unit is further configured to move the first topic into a do-not-disturb conversation group of a first user in response to an operation of closing notification performed on the first topic by the first user participating in the first topic.

In some embodiments, the control unit is further configured to display a subscribe topic control in a first topic-related interface of a second user not subscribed to the first topic, wherein the subscribe topic control, when triggered, causes the second user to subscribe to the first topic;

In some embodiments, the control unit is further configured to display an unsubscribe control in a first topic-related interface of a third user subscribed to the first topic, wherein the unsubscribe control, when triggered, causes the third user to unsubscribe to the first topic.

For the embodiment of the apparatus, because it basically corresponds to the method embodiment, it is only necessary to refer to the partial description of the method embodiment for the relevant points. The apparatus embodiments described above are merely illustrative, wherein the modules described as separate modules may or may not be separate. Some or all of the modules may be selected according to actual needs to achieve the purpose of the embodiment. those of ordinary skill in the art can understand and implement it without creative labor.

Above, the method and apparatus of the present disclosure are explained based on the embodiments and the application examples. In addition, the present disclosure also provides a terminal and a storage medium, which are described below.

Reference is now made to FIG. 9, which shows a schematic structural diagram of an electronic device (e.g., a terminal device or server) 800 suitable for use in implementing embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), a vehicle-mounted terminal (e.g., a vehicle-mounted navigation terminal), or the like, and a fixed terminal such as a digital TV, a desktop computer, or the like. The electronic device shown in the drawing is merely one example, and should not bring any limitation to the scope of functionality and use of embodiments of the present disclosure.

As shown in FIG. 9, an electronic device 800 may include a processing apparatus (e.g., a central processor, a graphics processor, etc.) 801 that may execute various appropriate actions and processes according to a program stored in a read-only memory (ROM) 802 or a program loaded into a random-access memory (RAM) 803 from a storage apparatus 808. In the RAM 803, various programs and data required for the operation of the electronic device 800 are also stored. The processing apparatus 801, the ROM 802 and the RAM 803 are connected to each other by a bus 804. An input/output (I/O) interface 805 is also connected to the bus 804.

In general, the following apparatuses may be connected to the I/O interface 805: input apparatus 806 including, for example, touchscreens, touchpads, keyboards, mice, cameras, microphones, accelerometers, gyroscopes, etc.; An output apparatus 807 including, for example, a liquid crystal display (LCD), a speaker, a vibrator, or the like; Storage apparatus 808 including, for example, magnetic tape, hard disk, etc.; And a communication apparatus 809. The communication apparatus 809 may allow the electronic device 800 to engage in wireless or wired communication with other devices to exchange data. While electronic device 800 is illustrated with various apparatuses, it should be understood that it is not required that all of the illustrated apparatuses be implemented or provided. More or fewer apparatuses may alternatively be implemented or provided.

In particular, according to an embodiment of the present disclosure, the processes described above with reference to the flow charts may be implemented as a computer software program. For example, embodiments of the present disclosure include a computer program product including a computer program carried on a computer readable medium, the computer program containing program codes for performing the methods illustrated by the flow charts. In such an embodiment, the computer program may be downloaded and installed from the network via the communication apparatus 809, or installed from the storage apparatus 808, or installed from the ROM 802. When this computer program is executed by the processing apparatus 801, the above-described functions defined in the methods of the embodiments of the present disclosure are performed.

It should be noted that the above-described computer-readable medium of the present disclosure may be a computer-readable signal medium or a computer-readable storage medium or any combination of both. A computer readable storage medium may be, for example, but not limited to, an electronic, magnetic, optical, electromagnetic, infrared, or semiconductor system, apparatus, or device, or any combination of the foregoing. More specific examples of a computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in connection with an instruction execution system, apparatus, or device. While in the present disclosure, a computer-readable signal medium may include a data signal propagated in baseband or as part of a carrier wave, in which computer-readable program codes are carried .. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to electrical wiring, optical fiber cable, RF (radio frequency), etc., or any suitable combination of the foregoing.

In some implementation, the clients, servers may communicate using any currently known or future developed network protocol, such as HTTP, and may be interconnected with any form or medium of digital data communication (e.g., a communication network). Examples of communication networks include a local area network (“LAN”), a wide area network (“WAN”), an internetwork (e.g., the Internet), and end-to-end networks (e.g., ad hoc end-to-end networks), as well as any currently known or future developed network.

The above-mentioned computer-readable medium may be included in the above-mentioned electronic device; It may also be present separately and not incorporated into the electronic device.

The above-mentioned computer-readable medium carries one or more programs which, when executed by the electronic device, cause the electronic device to perform the above-mentioned method of the present disclosure.

Computer program code for carrying out operations of the present disclosure may be written in one or more programming languages or combinations thereof, including an object oriented programming language such as Java, Smalltalk, C ++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present disclosure may be implemented by means of software or by means of hardware. Therein, the name of a unit does not in any case constitute a limitation of the unit per se.

The functionality described above herein can be performed, at least in part, by one or more hardware logic components. For example, and without limitation, illustrative types of hardware logic components that can be used include Field-programmable Gate Arrays (FPGA), Application-specific Integrated Circuits (ASIC), Application-specific Standard Products (ASSP), System-on-a-chip systems (SOC), Complex Programmable Logic Devices (CPLD), etc.

In the context of the present disclosure, a machine readable medium may be a tangible medium that can contain, or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer diskette, a hard disk, a random access memory (RAM), a read-only memory (ROM), an erasable programmable read-only memory (EPROM or Flash memory), an optical fiber, a convenient compact disc read-only memory (CD-ROM), an optical storage device, a magnetic storage device, or any suitable combination of the foregoing.

According to one or more embodiments of the present disclosure, there is provided an information processing method, including:
displaying a first message in a conversation detail page of a first conversation in response to an operation of sending the first message in the first conversation, wherein the first conversation is not a topic group;
creating a first topic including the first message in response to a topic creation operation for the first message in the first conversation; and
notifying members in the first conversation according to a preset notification policy when a new message appears in the first topic, wherein in the preset notification policy, different notification policies are adopted according to different degrees to which different members participate in the first topic.

An information processing method provided according to one or more embodiments of the present disclosure, the notifying members in the first conversation according to a preset notification policy when a new message appears in the first topic includes:
adopting a first notification policy for a member participating in the first topic in the first conversation and adopting a second notification policy for a member not participating in the first topic in the second conversation when a new message appears in the first topic,
wherein a notification strength of the first notification policy is higher than a notification strength of the second notification policy.

An information processing method provided according to one or more embodiments of the present disclosure, the member participating in the first topic in the first conversation including: a member who has replied to the first topic; or a member who has replied to the first topic and a member who has subscribed to the first topic through a topic subscription operation; or a member who has replied to the first topic and a member mentioned in the new message; or a member who has replied to the first topic, a member who has subscribed to the first topic through a topic subscription operation, and a member mentioned in the new message.

An information processing method provided according to one or more embodiments of the present disclosure, the adopting a first notification policy for a member participating in the first topic in the first conversation when a new message appears in the first topic including one or more of:
displaying first information of the first topic in a conversation list of the member participating in the first topic in a first conversation when the new message appears in the first topic;

An information processing method provided according to one or more embodiments of the present disclosure, the first information of the first topic including: identification information of the first topic and preview information of the new message.
pushing a voice alert notification or a visual alert notification to the member participating in the first topic in the first conversation when the new message appears in the first topic.

An information processing method provided according to one or more embodiments of the present disclosure, the method further includes:
displaying content of the first topic in a conversation detail page display area of a client interface of the member in response to triggering an operation of the first information of the first topic displayed in the conversation list.

An information processing method provided according to one or more embodiments of the present disclosure, the adopting a second notification policy for a member not participating in the first topic in the second conversation when a new message appears in the first topic including one or more of:
not notifying, in a conversation list of the member, the member not participating in the first topic in the first conversation when the new message appears in the first topic;
not pushing audio alert notification or visual alert notification to the member participating in the first topic in the first conversation when the new message appears in the first topic.

An information processing method provided according to one or more embodiments of the present disclosure, the method further includes:
moving the first topic into a do-not-disturb conversation group of a first user in response to an operation of closing notification performed on the first topic by the first user participating in the first topic.

An information processing method provided according to one or more embodiments of the present disclosure, the method further including one or more of: displaying a subscribe topic control in a first topic-related interface of a second user not subscribed to the first topic, wherein the subscribe topic control, when triggered, causes the second user to subscribe to the first topic;
displaying an unsubscribe control in a first topic-related interface of a third user subscribed to the first topic, wherein the unsubscribe control, when triggered, causes the third user to unsubscribe to the first topic.

An information processing apparatus provided according to one or more embodiments of the present disclosure, including a displaying unit, a control unit and a notification unit, the displaying unit is configured to display a first message in a conversation detail page of a first conversation in response to an operation of sending the first message in the first conversation, wherein the first conversation is not a topic group;
the control unit is configured to create a first topic including the first message in response to a topic creation operation for the first message in the first conversation;
the notification unit is configured to notify members in the first conversation according to a preset notification policy when a new message appears in the first topic, wherein in the preset notification policy, different notification policies are adopted according to different degrees to which different members participate in the first topic.

According to one or more embodiments of the present disclosure, there is provided a terminal, including at least one memory and at least one processor;
wherein the at least one memory is configured to store program code, and the at least one processor is configured to invoke the program code stored by the at least one memory to perform any of the methods described above.

According to one or more embodiments of the present disclosure, there is provided a computer-readable storage medium for storing program code which, when executed by a processor, causes the processor to perform any of the methods described above.

The foregoing description is merely the preferred embodiments of the present disclosure and illustrative of the principles of the technology employed. It should be understood by those skilled in the art that the scope of the disclosure involved in the present disclosure is not limited to the technical solution formed by the specific combination of the above technical features, but also covers other technical solutions formed by any combination of the above technical features or their equivalent features without departing from the concept of the above disclosure. For example, the above-described features can be substituted with the technical features disclosed in the present disclosure (but not limited to) having similar functions.

Further, while operations are depicted in a particular order, this should not be understood as requiring that these operations be performed in the particular order shown or in sequential order. In certain circumstances, multitasking and parallel processing may be advantageous. Likewise, while several specific implementation details are contained in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. An information processing method, comprising:
displaying a first message in a conversation detail page of a first conversation in response to an operation of sending the first message in the first conversation, wherein the first conversation is not a topic group;
creating a first topic including the first message in response to a topic creation operation for the first message in the first conversation; and
notifying members in the first conversation according to a preset notification policy when a new message appears in the first topic, wherein in the preset notification policy, different notification policies are adopted according to different degrees to which different members participate in the first topic.

2. The method of claim 1, wherein the notifying members in the first conversation according to a preset notification policy when a new message appears in the first topic comprises:
adopting a first notification policy for a member participating in the first topic in the first conversation and adopting a second notification policy for a member not participating in the first topic in the second conversation when a new message appears in the first topic,
wherein a notification strength of the first notification policy is higher than a notification strength of the second notification policy.

3. The method of claim 2, the member participating in the first topic in the first conversation comprising:
a member who has replied to the first topic; or
a member who has replied to the first topic and a member who has subscribed to the first topic through a topic subscription operation; or
a member who has replied to the first topic and a member mentioned in the new message; or
a member who has replied to the first topic, a member who has subscribed to the first topic through a topic subscription operation, and a member mentioned in the new message.

4. The method of claim 2, the adopting a first notification policy for a member participating in the first topic in the first conversation when a new message appears in the first topic comprising one or more of:
displaying first information of the first topic in a conversation list of the member participating in the first topic in a first conversation when the new message appears in the first topic;
pushing a voice alert notification or a visual alert notification to the member participating in the first topic in the first conversation when the new message appears in the first topic.

5. The method of claim 4, the first information of the first topic comprising:
identification information of the first topic and preview information of the new message.

6. The method of claim 4, further comprising:
displaying content of the first topic in a conversation detail page display area of a client interface of the member in response to triggering an operation of the first information of the first topic displayed in the conversation list.

7. The method of claim 2, the adopting a second notification policy for a member not participating in the first topic in the second conversation when a new message appears in the first topic comprising one or more of:
not notifying, in a conversation list of the member, the member not participating in the first topic in the first conversation when the new message appears in the first topic;
not pushing audio alert notification or visual alert notification to the member not participating in the first topic in the first conversation when the new message appears in the first topic.

8. The method of claim 1, further comprising:
moving the first topic into a do-not-disturb conversation group of a first user in response to an operation of closing notification performed on the first topic by the first user participating in the first topic.

9. The method of claim 1, further comprising one or more of:
displaying a subscribe topic control in a first topic-related interface of a second user not subscribed to the first topic, wherein the subscribe topic control, when triggered, causes the second user to subscribe to the first topic;
displaying an unsubscribe control in a first topic-related interface of a third user subscribed to the first topic, wherein the unsubscribe control, when triggered, causes the third user to unsubscribe to the first topic.

10. (canceled)

11. A terminal, comprising:
at least one memory and at least one processor;
wherein the at least one memory is configured to store program code, and the at least one processor is configured to invoke the program code stored by the at least one memory to perform an information processing method, the method comprises:
displaying a first message in a conversation detail page of a first conversation in response to an operation of sending the first message in the first conversation, wherein the first conversation is not a topic group;
creating a first topic including the first message in response to a topic creation operation for the first message in the first conversation; and
notifying members in the first conversation according to a preset notification policy when a new message appears in the first topic, wherein in the preset notification policy, different notification policies are adopted according to different degrees to which different members participate in the first topic.

12. A non-transitory computer-readable storage medium for storing program code which, when executed by a processor, causes the processor to perform an information processing method, the method comprises:
displaying a first message in a conversation detail page of a first conversation in response to an operation of sending the first message in the first conversation, wherein the first conversation is not a topic group;
creating a first topic including the first message in response to a topic creation operation for the first message in the first conversation; and
notifying members in the first conversation according to a preset notification policy when a new message appears in the first topic, wherein in the preset notification policy, different notification policies are adopted according to different degrees to which different members participate in the first topic.

13. The terminal of claim 11, wherein the notifying members in the first conversation according to a preset notification policy when a new message appears in the first topic comprises:
adopting a first notification policy for a member participating in the first topic in the first conversation and adopting a second notification policy for a member not participating in the first topic in the second conversation when a new message appears in the first topic,
wherein a notification strength of the first notification policy is higher than a notification strength of the second notification policy.

14. The terminal of claim 13, the member participating in the first topic in the first conversation comprising:
a member who has replied to the first topic; or
a member who has replied to the first topic and a member who has subscribed to the first topic through a topic subscription operation; or
a member who has replied to the first topic and a member mentioned in the new message; or
a member who has replied to the first topic, a member who has subscribed to the first topic through a topic subscription operation, and a member mentioned in the new message.

15. The terminal of claim 13, the adopting a first notification policy for a member participating in the first topic in the first conversation when a new message appears in the first topic comprising one or more of:
displaying first information of the first topic in a conversation list of the member participating in the first topic in a first conversation when the new message appears in the first topic;
pushing a voice alert notification or a visual alert notification to the member participating in the first topic in the first conversation when the new message appears in the first topic.

16. The terminal of claim 15, the first information of the first topic comprising: identification information of the first topic and preview information of the new message.

17. The terminal of claim 15, wherein the method further comprising:
displaying content of the first topic in a conversation detail page display area of a client interface of the member in response to triggering an operation of the first information of the first topic displayed in the conversation list.

18. The terminal of claim 13, the adopting a second notification policy for a member not participating in the first topic in the second conversation when a new message appears in the first topic comprising one or more of:
not notifying, in a conversation list of the member, the member not participating in the first topic in the first conversation when the new message appears in the first topic;
not pushing audio alert notification or visual alert notification to the member not participating in the first topic in the first conversation when the new message appears in the first topic.

19. The terminal of claim 11, wherein the method further comprising:
moving the first topic into a do-not-disturb conversation group of a first user in response to an operation of closing notification performed on the first topic by the first user participating in the first topic.

20. The terminal of claim 11, wherein the method further comprising one or more of:
displaying a subscribe topic control in a first topic-related interface of a second user not subscribed to the first topic, wherein the subscribe topic control, when triggered, causes the second user to subscribe to the first topic;
displaying an unsubscribe control in a first topic-related interface of a third user subscribed to the first topic, wherein the unsubscribe control, when triggered, causes the third user to unsubscribe to the first topic.

21. The non-transitory computer-readable storage medium of claim 12, wherein the notifying members in the first conversation according to a preset notification policy when a new message appears in the first topic comprises:
adopting a first notification policy for a member participating in the first topic in the first conversation and adopting a second notification policy for a member not participating in the first topic in the second conversation when a new message appears in the first topic,
wherein a notification strength of the first notification policy is higher than a notification strength of the second notification policy.
